(19) United States
(12) Patent Application Publication
(10) Pub. No.: US 2026/0187934 A1
(43) Pub. Date: Jul. 2, 2026

(54) DATA PROCESSING METHOD AND APPARATUS, DEVICE, MEDIUM, AND PRODUCT

(71) Applicant: Beijing Zitiao Network Technology Co., Ltd., Beijing (CN)

(72) Inventors: Zhixing CHEN, Beijing (CN); Zhihong FU, Beijing (CN); Yuan GAO, Beijing (CN); Kang DU, Beijing (CN)

(21) Appl. No.: 19/427,794

(22) Filed: Dec. 19, 2025

(30) Foreign Application Priority Data
Dec. 31, 2024 (CN) 202411997711.0

(51) Int. Cl. G06T 17/20; G06T 7/10

(52) U.S. Cl. CPC G06T 17/20; G06T 7/10; G06T 2207/20132

(57) ABSTRACT

The present application discloses a data processing method and apparatus, device, medium and product. The method comprises: acquiring a target image, wherein the target image is configured for describing a target object; predicting projection point coordinates of vertices in a 3-dimensional mesh of the target object on the target image according to image features of the target image, wherein the 3-dimensional mesh is configured for describing a state of the target object in a 3-dimensional space; predicting at least one parameter according to the image features and the projection point coordinates, wherein the at least one parameter is configured for driving a 3-dimensional deformable model to obtain the 3-dimensional mesh.

### CROSS-REFERENCE TO RELATED APPLICATIONS

The present application claims the benefit of priority to the Chinese patent application No. 202411997711.0 filed with Chinese Patent Office on December 31, 2024, which is hereby incorporated by reference in its entirety into the present application.

### TECHNICAL FIELD

The present application relates to the data processing technical field, and in particular a data processing method and apparatus, device, medium, and product.

### BACKGROUND

For some scenes, these scenes may have the following requirements: performing a 3-Dimensionality (3D) reconstruction based on 2-Dimensionality (2D) images provided by users to obtain a 3D mesh, so that the 3D mesh is used for describing in what state the object (such as an animal) described by the 2D images is in a 3D space.

### SUMMARY

In order to meet the above requirements, the present application provides a data processing method and apparatus, device, medium, and product.

In order to achieve the above purpose, the technical solution provided by the present application is as follows.

The present application provides a data processing method, which comprises: acquiring a target image, wherein the target image is used for describing a target object; predicting projection point coordinates of vertices in a 3-dimensional mesh of the target object on the target image according to image features of the target image, wherein the 3-dimensional mesh is used for describing a state of the target object in a 3-dimensional space; predicting at least one parameter according to the image features and the projection point coordinates, wherein the at least one parameter is used for driving a 3-dimensional deformable model to obtain the 3-dimensional mesh.

In one possible implementation, the at least one parameter comprises shape parameters of the target object, bone rotation parameters of the target object, global rotation parameters of the target object and global translation parameters of the target object.

In one possible implementation, the predicting projection point coordinates of vertices in a 3-dimensional mesh of the target object on the target image according to image features of the target image comprises: predicting projection point coordinates of all vertices in the 3-dimensional mesh on the target image according to the image features; or, predicting projection point coordinates of a portion of vertices in the 3-dimensional mesh on the target image according to the image features, wherein the importance degree of the portion of vertices is higher than that of the vertices other than the portion in all the vertices.

In a possible implementation, the method is applied to an electronic device, and the method further comprises: determining a 3-dimensional reconstruction constraint according to 3-dimensional reconstruction requirements of the electronic device and/or a resource usage state of the electronic device, wherein the 3-dimensional reconstruction constraint is used for indicating a usage upper limit of a 3-dimensional reconstruction process realized based on the target image with at least one resource, and the at least one resource comprises a portion or all of various computing resources and time; the determination process of the projection point coordinates comprises: if the usage upper limit indicated by the 3-dimensional reconstruction constraint exceeds a preset threshold value, predicting projection point coordinates of all vertices in the 3-dimensional mesh on the target image according to the image features; if the usage upper limit indicated by the 3-dimensional reconstruction constraint does not exceed a preset threshold value, predicting projection point coordinates of a portion of vertices in the 3-dimensional mesh on the target image according to the image features.

In one possible implementation, the acquiring process of the target image comprises: acquiring an original image, wherein the original image is configured for describing the target object; performing a cropping processing on the original image according to a position of the target object in the original image to obtain a cropped image, wherein the cropped image is configured for describing an area indicated by the position in the original image; determining the target image according to the cropped image.

In one possible implementation, the determining the target image according to the cropped image comprises: performing an adjustment processing on the cropped image according to a preset resolution to obtain the target image, wherein a resolution of the target image is the preset resolution, and the preset resolution is smaller than that of the cropped image.

In one possible implementation, the method further comprises: acquiring an affine transformation matrix, wherein the affine transformation matrix is configured for indicating the corresponding relationships between pixel points in the target image and pixel points in the original image; the predicting at least one parameter according to the image features and the projection point coordinates comprises: predicting the at least one parameter according to the image features, the projection point coordinates and the affine transformation matrix.

In one possible implementation, the target image is the cropped image, and the affine transformation matrix is determined according to the cropping processing; or, the target image is obtained by performing an adjustment processing on the cropped image according to the preset resolution, and the affine transformation matrix is determined according to the cropping processing and the adjustment processing.

In one possible implementation, the method further comprises: acquiring a focal length used when shooting the original image; the predicting at least one parameter according to the image features and the projection point coordinates comprises: predicting the at least one parameter according to the image features, the projection point coordinates and the focal length.

In one possible implementation, the method is applied to an electronic device; an acquisition process of the focal length comprises: if the focal length used when shooting the original image is stored in a storage space of the electronic device, reading the focal length from the storage space; if the focal length used when shooting the original image is not stored in a storage space of the electronic device, acquiring a preset focal length.

In one possible implementation, the at least one parameter is determined by using a target model, and the target model comprises a feature extraction network, a first prediction network and a second prediction network; the feature extraction network is configured for extracting the image features from the target image; the first prediction network is configured for predicting projection point coordinates of vertices in the 3-dimensional mesh on the target image according to the image features; the second prediction network is configured for predicting at least one parameter according to the image features and the projection point coordinates.

In one possible implementation, the target image is obtained by processing the original image; the method further comprises: acquiring true values corresponding to the projection point coordinates and true values corresponding to the at least one parameter; determining a prediction loss according to a difference between the projection point coordinates and the true values corresponding to the projection point coordinates and a difference between the at least one parameter and the true values corresponding to the at least one parameter; determining a re-projection loss according to a difference between the projection point coordinates calculated based on the at least one parameter and the true values corresponding to the projection point coordinates; determining a segmentation loss according to a difference between edge information calculated based on the at least one parameter and a segmentation result of the original image, wherein the edge information is configured for describing edges predicted for the target object; updating the target model according to the prediction loss, the re-projection loss and the segmentation loss.

The present application provides a data processing apparatus, comprising: a first acquisition unit for acquiring a target image, wherein the target image is configured for describing a target object; a first prediction unit for predicting projection point coordinates of vertices in a 3-dimensional mesh of the target object on the target image according to image features of the target image, wherein the 3-dimensional mesh is configured for describing a state of the target object in a 3-dimensional space; a second prediction unit for predicting at least one parameter according to the image features and the projection point coordinates, wherein the at least one parameter is configured for driving a 3-dimensional deformable model to obtain the 3-dimensional mesh.

The present application provides an electronic device, which comprises: a processor and a memory; the memory is configured for storing instructions or computer programs; the processor is configured for executing the instructions or computer programs in the memory, so that the electronic device performs the data processing method provided by the present application.

The present application provides a computer-readable medium, wherein instructions or computer programs are stored in the computer-readable medium, and when run on a device, cause the device to perform the data processing method provided by the present application.

The present application provides a computer program product, comprising computer programs carried on a non-transitory computer-readable medium, the computer programs comprising program codes for performing the data processing method provided by the present application.

### BRIEF DESCRIPTION OF THE DRAWINGS

In order to more clearly explain the technical solution in the embodiments of the present application or the related technologies, the drawings needed in the description of the embodiments or related technologies will be briefly introduced below. Obviously, the drawings in the following description are only some embodiments recited in the present application. For those skilled in the field, other drawings can be obtained according to these drawings without inventive effort.

FIG. 1 is a flow diagram of a data processing method provided by an embodiment of the present application;

FIG. 2 is a schematic diagram of a 3-dimensional reconstruction process provided by an embodiment of the present application;

FIG. 3 is a schematic structural diagram of a data processing apparatus provided by an embodiment of the present application;

FIG. 4 is a schematic structural diagram of an electronic device provided by an embodiment of the present application.

### DETAILED DESCRIPTION

Through research, it is found that in some scenes, such as a 3D reconstruction scene of a whole body of an animal, conversion from 2D images to a 3D mesh can be realized by means of a 3D deformable model. The working principle of the 3D deformable model is to input some parameters (such as shape parameters, bone rotation parameters, global rotation parameters, global translation parameters, etc.) to the 3D deformable model to drive the 3D deformable model to generate the 3D mesh. Apparently, these parameters need to be predicted in order to realize the 3D reconstruction.

Through research, it is also found that the prediction process of the above parameters can include: after acquiring an image 1 shot for a certain object (such as a dog), first detecting a position of the object from the image 1; then cropping an image 2 for describing an area indicated by the position out of the image 1; then, predicting a segmented image of the object and 2D bone points of the object according to the image 2; then, predicting shape parameters of the object according to the image 2 and the segmented image; then, predicting the bone rotation parameters of the object, the global rotation parameters of the object, the global translation parameters of the object and the camera focal length of the image according to the shape parameters, the segmented image and the 2D bone points.

Through research, it is also found that the above prediction process has defects as shown in the following ①-④.

① Because the resolution of the segmented image is close to that of the image 2, the resolution of the segmented image is relatively large, so that the prediction process needs to perform multi-step calculation at a large resolution scale, resulting in relatively high time overhead and computing resource overhead. However, if the segmented image is directly discarded, the edge information cannot be provided by the 2D bone points, which will lead to the defect of poor edge fit of the final 3-dimensional reconstruction result.

②Because both the global rotation parameters and the global translation parameters are obtained based on the cropped image (such as the image 2) instead of the original image (such as the image 1), these two parameters can only describe the characteristics such as global rotation and global translation presented by the cropped image, so that these two parameters cannot describe the characteristics such as global rotation and global translation presented by the original image, thus leading to the occurrence of a relatively poor rendering result, such as an incorrect global translation state or an incorrect global rotation state or other effects, when these two parameters are used as camera external parameters for some rendering (such as rendering back to the image space described by the original image).

③ There is a certain relationship between the focal length used when shooting an image and the size of the image, so that the camera focal length predicted based on the cropped image can be adapted to the size of the cropped image. However, because the size of the original image is larger than that of the cropped image, the predicted camera focal length is not adapted to the original image, for example, the predicted camera focal length is smaller than the focal length used to shoot the original image, thus leading to the occurrence of a relatively poor rendering effect, such as an enlarged rendering result generated based on the 3D mesh, when the predicted camera focal length is used as the camera internal parameter for rendering.

④ Because the camera focal length is obtained by prediction, there is a certain error in the camera focal length, which makes the camera focal lengths predicted based on different frames fluctuate in a 3D tracking scene, thus leading to an unstable rendering effect. In addition, because some processing units (such as an effect production unit) used for rendering for the 3D mesh are configured with camera fixed-focus constraints, these processing units are not compatible with the prediction process in which the focal length changes. In addition, because different image acquisition devices have different focal lengths, the accuracy of prediction of other parameters (such as the shape parameters, the bone rotation parameters, the global rotation parameters, the global translation parameters, etc.) will be seriously affected when the focal length is inaccurately predicted.

Based on the above research, in order to overcome at least a portion of the above defects, such as those described by ① above, the present application provides a data processing method, which includes: after acquiring a target image for describing a target object (such as an animal), first predicting projection point coordinates of vertices in a 3D mesh of the object on the target image according to image features of the target image, so that the projection point coordinates can indicate the corresponding relationships between pixel points in the target image and the vertices in the 3D mesh, so that the projection point coordinates can describe some characteristics predicted for the 3D mesh to a certain extent, such as vertex distribution characteristics, edge characteristics and the like; then predicting at least one parameter according to the image features and the projection point coordinates, so that these parameters can represent the driving parameters needed when generating the 3D mesh, so as to drive the 3D deformable model by using the at least one parameter to obtain the 3D mesh, so that the 3D mesh can describe the state of the object in the 3D space, thus generating the 3D mesh based on the 2D images.

Apparently, the projection point coordinates predicted by the present application carry the edge information and bone point distribution information of the target object, so that the projection point coordinates can be used in replacement of the above segmented image and the above 2D bone points. Moreover, because the data amount of the projection point coordinates is relatively small, the projection point coordinates fall into the category of sparse data compared with the segmented image, so that the computation amount of the prediction process realized based on the projection point coordinates is greatly reduced, thus making both the time overhead and computing resource overhead of the prediction process relatively small. In this way, the prediction process is suitable for deployment not only on a device with rich resources, but also on a device with limited resources, thus expanding the application scope of the prediction process.

In addition, the execution subject of the data processing method is not limited in the present application, for example, the method can be applied to a terminal device or a server. For another example, the method can also be implemented by means of the data interaction process between the terminal device and the server. The terminal device can be a smart phone, a computer, a Personal Digital Assistant (PDA), a tablet computer, etc. The server can be a stand-alone server, a cluster server or a cloud server.

In order to make those skilled in the art better understand the solution of the present application, the technical solution in the embodiments of the present application will be described clearly and completely with the attached drawings of the present application. Obviously, the described embodiments are only a portion of the embodiments of the present application, not all the embodiments. Based on the embodiments in the present application, all other embodiments obtained by those skilled in the art without inventive effort belong to the protection scope of the present application.

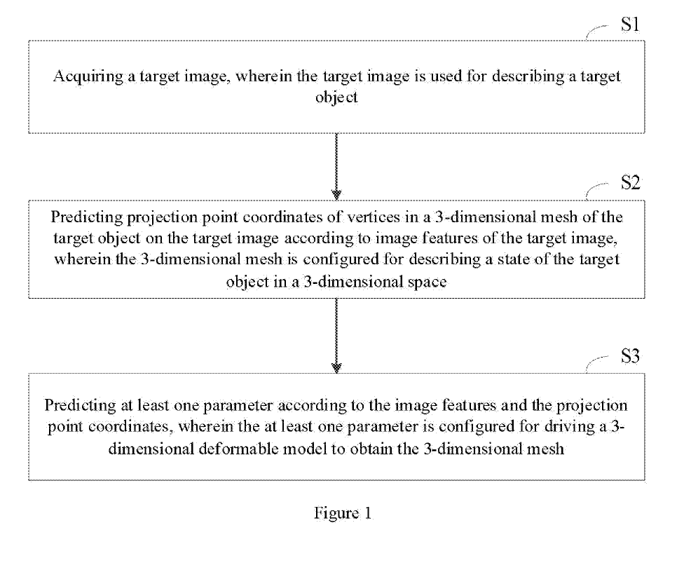

In order to better understand the technical solution provided by the present application, the data processing method provided by the present application will be explained with some attached drawings. As shown in FIG. 1, the data processing method provided by the embodiment of the present application includes the S1-S3 below.

S1: acquiring a target image, wherein the target image is used for describing a target object.

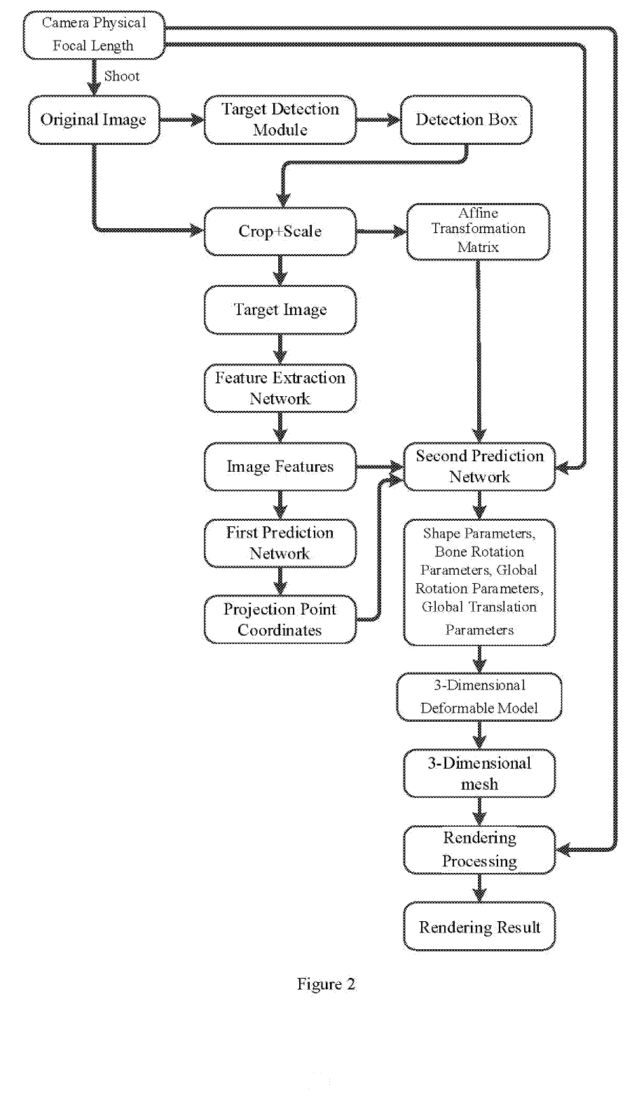

The target image refers to an image with 3-dimensional reconstruction requirements, such as the target image shown in FIG. 2. The target image is used for describing the target object (such as a dog). It should be noted that the target object can refer to the foreground of the target image. Moreover, the implementation of the target object is not limited in the present application, for example, in some scenes, the target object can be implemented by using an animal. For another example, in some scenes, the target object can be implemented by using a person or a virtual image.

In addition, the implementation of S1 above is not limited in the present application. For example, in some scenes, S1 can specifically be: taking an image acquired by some image acquisition device as the target image.

Through research, it is found that for an image acquired by using an image acquisition device, if most areas in the image are the background, the background will easily interfere with the 3-dimensional reconstruction process based on the image, so in order to overcome this interference, the above S1 can specifically include the following steps 11 to 13.

Step 11: acquiring an original image, wherein the original image is used for describing the target object.

It should be noted that the original image is not limited in the present application, for example, the original image can refer to an image acquired by some image acquisition device, such as the original image shown in FIG. 2.

Step 12: performing a cropping processing on the original image according to a position of the target object in the original image to obtain a cropped image, wherein the cropped image is used for describing an area indicated by the position in the original image.

The position of the target object in the original image is used for describing the area occupied by the target object in the original image. Moreover, the way to acquire the position is not limited in the present application, for example, it can be implemented by using any target detection method, such as any model with the target detection function (such as the target detection model shown in FIG. 2).

Apparently, for some scenes, after acquiring the original image shot for the target object, it is possible to use a pre-built target detection model (such as an animal detection model) to detect the position of the object in the original image to obtain a detection box (such as the detection box shown in FIG. 2), and the detection box can be represented by using the coordinate of a vertex in the detection box, the width of the detection box and the height of the detection box, so that the detection box can be recorded as B(x, y, w, h), thus enabling the detection box to describe the position of the object in the original image. It should be noted that B is used for representing the detection box; (x, y) is used for representing the coordinate of a vertex (such as the vertex in the upper left corner) in the detection box; w represents the width of the detection box; h represents the height of the detection box. In addition, the detection box can also be represented in other ways, which are not limited in the present application.

Based on the related contents of the above step 12, it can be learned that, acquiring the position of the target object in the original image is followed by cropping an area indicated by the position out of the original image to obtain a cropped image, so that the cropped image can represent an area occupied by the target object in the original image, namely a foreground area, so that the cropped image carries as little background information as possible, thus suffering as little interference as possible when performing the 3-dimensional reconstruction based on the cropped image.

Step 13: determining the target image according to the above cropped image.

It should be noted that the implementation of the above step 13 is not limited in the present application, for example, it can specifically be: determining the above cropped image as the target image. Apparently, in one possible implementation, the target image is obtained by performing a cropping processing for the original image.

Through research, it is found that in some scenes, because the resolution of the cropped image is relatively high, the 3-dimensional reconstruction realized based on the cropped image still has a large computation amount. Therefore, in order to better reduce the computation amount, the above step 13 can be: performing an adjustment processing (scaling as shown in FIG. 2) on the cropped image according to a preset resolution to obtain the target image, so that a resolution of the target image is the preset resolution, wherein, because the preset resolution is smaller than that of the cropped image, the computation amount of the 3-dimensional reconstruction realized based on the image with the preset resolution is smaller than that of the 3-dimensional reconstruction realized based on the cropped image.

It should be noted that the way to acquire the preset resolution is not limited in the present application, for example, the preset resolution can be determined according to the requirements in an actual application scene (such as requirements of the resolution, or requirements of the upper limit of the computation amount, or requirements of the upper limit of the computing resource overhead, etc.). For another example, if the target image needs to be subsequentially processed by using a certain machine learning model, the preset resolution can be determined according to requirements of the input data size of each network in the model, so that the image scaled according to the preset resolution can meet requirements of these input data sizes.

Based on the related contents of the above steps 11 to 13, it can be learned that, acquiring the original image shot by using a certain device (such as a mobile phone) for the target object is followed by first detecting the position of the object in the original image; then performing a cropping processing on the original image according to the position to obtain a cropped image, so that the cropped image can describe image information within the area where the object is located in the original image; then, scaling the cropped image to a preset resolution to obtain the target image, so that the target image can describe the object at the preset resolution.

S2: predicting projection point coordinates of vertices in a 3-dimensional mesh of the target object on the target image according to image features of the target image, wherein the 3-dimensional mesh is used for describing a state of the target object in a 3-dimensional space.

The image features of the target image are obtained by performing feature extraction for the target image, so that the image features can represent the image information carried by the target image. It should be noted that the implementation of feature extraction is not limited in the present application, for example, it can be implemented by using any method of performing feature extraction for the image, such as a machine learning model with an extraction function of the image features or a feature extraction network as shown in FIG. 2.

The 3-dimensional mesh of the target object is a result obtained by performing 3-dimensional reconstruction for the target image, such as the 3-dimensional mesh shown in FIG. 2, so that the 3-dimensional mesh can represent the state of the target object in 3-dimensional space. It should be noted that the 3-dimensional mesh is composed of some vertices and lines connecting these vertices.

In addition, for any vertex in the 3-dimensional mesh of the target object, the projection point coordinate of the vertex on the target image refers to the projection result which is predicted for the vertex and presented when projecting the vertex into the 2-dimensional image space described by the target image, so that the projection point coordinate can represent the predicted state of the vertex in the 2-dimensional space, thus enabling the projection point coordinate to represent the characteristics owned by the vertex prediction to a certain extent. It should be noted that the way to predict the projection point coordinate is not limited in the present application, for example, it can be implemented by using any prediction method, such as a machine learning model with prediction performance or a first prediction network shown in FIG. 2.

In addition, the implementation of the above S2 is not limited in the present application. For example, in order to better improve the accuracy, S2 can specifically be: predicting the projection point coordinates of all vertices in the 3-dimensional mesh of the target object on the target image according to the image features of the target image, so that these projection point coordinates can represent the predicted state of the 3-dimensional mesh in the 2-dimensional space, thus enabling these projection point coordinates to represent the prediction result of the vertex distribution states in the 3-dimensional mesh to a certain extent.

For another example, in order to better reduce the computation amount, the above S2 can specifically be: predicting projection point coordinates of a portion of vertices (such as relatively important vertices) in the 3-dimensional mesh of the target object on the target image according to the image features of the target image, so as to reduce the computation amount by sampling the projection points of the 3-dimensional mesh, which is beneficial to better reduce the time overhead and the computing resource overhead. Because the importance degree of this portion of vertices is higher than that of the vertices other than this portion of all the vertices, this portion of vertices can represent the relatively important vertices in the 3-dimensional mesh. Thus, the projection point coordinates of this portion of the vertices on the target image can represent some characteristics of the 3-dimensional mesh, such as edge contours and a portion of bone points states.

It should be noted that the way to acquire the above portion of vertices is not limited in the present application, for example, the portion of vertices can be the vertices which are pre-calibrated by relevant personnel and can describe some characteristics of the 3-dimensional mesh (such as edge information + distribution states of bone points). For another example, in order to improve the flexibility, the determination process of this portion of vertices includes: first, calculating the influence degree of each vertex in the 3-dimensional mesh on the target information (such as edge information + distribution states of bone points); then determining the importance degree of each vertex according to the comparison result of these influence degrees; then, according to these importance degrees, sampling these vertices to obtain the relatively important vertices (such as the vertices whose importance degrees exceed a preset threshold value or the vertices whose importance degrees rank higher) as this portion vertices.

Through research, it is found that, for the execution device (such as an electronic device) of the data processing method in the present application, if the device requires relatively high real-time performance, in order to improve the real-time performance, it is possible to select to predict the projection point coordinates of a portion of vertices on the target image to reduce the time overhead; if the device requires relatively low real-time performance, in order to improve the accuracy, it is possible to select to predict the projection point coordinates of all vertices on the target image to improve the reconstruction effect; if the device has relatively few remaining resources at the current moment, in order to reduce the computing resource overhead, it is possible to select to predict the projection point coordinates of a portion of vertices on the target image to ensure that the data processing method occupies as few computing resources as possible; if the device has relatively plentiful remaining resources at the current moment, in order to improve the accuracy, it is possible to select to predict the projection point coordinates of all vertices on the target image to improve the reconstruction effect.

Based on the above research, in order to better improve the flexibility, when the data processing method provided in the present application is applied to an electronic device (such as a terminal device or a server), the above S2 can include the following steps 21-23.

Step 21: determining a 3-dimensional reconstruction constraint according to 3-dimensional reconstruction requirements of the electronic device and/or a resource usage state of the electronic device, wherein the 3-dimensional reconstruction constraint is used for indicating a usage upper limit of a 3-dimensional reconstruction process realized based on the target image with at least one resource, and the at least one resource comprises a portion or all of various computing resources and time.

The 3-dimensional reconstruction requirements of the electronic device refer to the requirements that need to be met when performing the 3-dimensional reconstruction process by using the electronic device, such as the upper limit of the running time consumption of the 3-dimensional reconstruction process or the upper limit of various computing resources consumed when performing the 3-dimensional reconstruction process. It should be noted that the way to acquire the 3-dimensional reconstruction requirements is not limited in the present application, for example, the 3-dimensional reconstruction requirements can be previously specified by relevant personnel. For another example, the 3-dimensional reconstruction requirements can be determined based on the real-time running situation (such as the remaining resource situation) owned by the electronic device itself.

The resource usage state of the electronic device is used for describing in real time how many computing resources the electronic device has used, so that the resource usage state can reflect to a certain extent the amount of resources that can be used for performing the 3-dimensional reconstruction process.

The 3-dimensional reconstruction constraint is used for indicating the usage upper limit of the 3-dimensional reconstruction process realized based on the target image with at least one resource. It should be noted that the implementation of the at least one resource is not limited in the present application, for example, the at least one resource can include time, so that the 3-dimensional reconstruction constraint can indicate the maximum time overhead allowed when performing the 3-dimensional reconstruction process. For another example, the at least one resource can include one or more computing resources, such as memory, Central Processing Unit (CPU) and other computing resources, so that the 3-dimensional reconstruction constraint can indicate the maximum amount of resources allowed to be occupied with these computing resources when performing the 3-dimensional reconstruction process. For another example, the at least one resource can include time and at least one computing resource.

In addition, the implementation of the above step 21 is not limited in the present application, for example, it can be implemented by using any method of predicting another data based on some data, for example, by means of a pre-built machine learning model that can predict the 3-dimensional reconstruction constraint based on the 3-dimensional reconstruction requirements and resource usage state.

Step 22: if the usage upper limit indicated by the above 3-dimensional reconstruction constraint exceeds a preset threshold value, it can be determined that the 3-dimensional reconstruction process realized based on the target image can be allocated sufficient resources, so projection point coordinates of all vertices in the 3-dimensional mesh of the target object on the target image are predicted according to the image features of the target image, so that these projection point coordinates can describe the characteristics owned by the 3-dimensional mesh as comprehensively as possible, which is beneficial to improving the 3-dimensional reconstruction effect.

It should be noted that the above preset threshold value can be pre-set according to the actual application scene.

Step 23: if the usage upper limit indicated by the above 3-dimensional reconstruction constraint does not exceed a preset threshold value, it can be determined that the 3-dimensional reconstruction process realized based on the target image can be allocated only a few resources, so projection point coordinates of a portion of vertices in the 3-dimensional mesh of the target object on the target image are predicted according to the image features of the target image so as to ensure the 3-dimensional reconstruction process to be properly performed with the few resources. Apparently, in one possible implementation, the portion of vertices can also be determined according to the usage upper limit, so as to ensure that the number of vertices in the portion of vertices is adapted to the usage upper limit, thus effectively avoiding the defect that too many resources are occupied due to too many predicted projection point coordinates.

Based on the related contents of the above steps 21 to 23, it can be learned that, in some scenes, it is possible to flexibly select to predict projection point coordinates of a portion of vertices on the target image or select to predict projection point coordinates of all vertices on the target image by means of some characteristics owned by the electronic device, so as to ensure that the 3-dimensional reconstruction process can better meet these characteristics.

Based on the related content of the above S2, after acquiring the target image for describing the target object, it is possible to first extract image features from the target image, so that the image features can better represent the information carried by the target image, such as the characteristics presented by the target object in 2-dimensional space; then, predict the projection point coordinates of a portion or all of vertices in the 3-dimensional mesh of the target object on the target image according to the image features, so that these projection point coordinates can describe some characteristics of the 3-dimensional mesh of the target object (such as edge information + distribution states of bone points), so that these projection point coordinates can represent the edge information of the target object and distribution information of bone points, thus enabling these projection point coordinates to be used in replacement of the above segmented image and the above 2D bone points, which is beneficial to reducing the computation amount.

S3, predicting at least one parameter according to the image features and the projection point coordinates, wherein the at least one parameter is used for driving a 3-dimensional deformable model to obtain the 3-dimensional mesh.

The at least one parameter refers to parameters for driving the 3-dimensional deformable model, which are predicted for the target object described by the target image, so that these parameters can describe some characteristics of the 3-dimensional mesh reconstructed for the target object.

It should be noted that the implementation of the 3-dimensional deformable model is not limited in the present application. For example, in some scenes, such as a 3D reconstruction scene of a whole body of an animal, the 3-dimensional deformable model can be implemented by using a Skinned Multi-Animal Linear Model of 3-dimensional Animal Shape (SMAL). The SMAL is a 3D animal deformable model, and a uniquely determined animal 3D mesh can be generated by inputting specific parameters into the model. The SMAL can include two sets of adjustable parameters, one set is shape parameters, which are used for adjusting the species, appearance and body shape of the animal; the other set is bone rotation parameters, which are used for adjusting the rotation angle of each joint of the animal, so that the animal presents different postures. In addition, in order to better realize the 3D tracking effect, the SMAL can also include three dimensions of global rotation parameters and three dimensions of global translation parameters, so that the global rotation parameters can describe the rotation state of the animal in the world coordinate system, such as the orientation of the animal, and the global translation parameters can describe the position of the animal in the world coordinate system.

Apparently, in one possible implementation, the above at least one parameter can include shape parameters of the target object, bone rotation parameters of the target object, global rotation parameters of the target object, and global translation parameters of the target object. The shape parameters are used for describing shape characteristics of the target object, such as appearance, body shape, wearing and other characteristics. The bone rotation parameters are used for describing posture characteristics of the target object, such as the posture of each body part and other characteristics. The global rotation parameters are used for describing rotation characteristics of the target object in the world coordinate system, such as the orientation of the face and other characteristics. The global translation parameters are used for describing the position of the target object in the world coordinate system.

In addition, the way to predict the above at least one parameter is not limited in the present application, for example, it can be implemented by using any machine learning model with prediction performance or a second prediction network as shown in FIG. 2.

Apparently, in one possible implementation, the above S3 can specifically be: inputting the image features and the projection point coordinates into the second prediction network to obtain at least one parameter output by the second prediction network.

Based on the related contents of the above S1 to S3, the 3D reconstruction solution provided by the present application includes: after acquiring the target image for describing the target object (such as an animal), first predicting projection point coordinates of vertices in a 3D mesh of the target object on the target image according to image features of the target image, so that the projection point coordinates can indicate the corresponding relationships between pixel points in the target image and the vertices in the 3D mesh, thus enabling the projection point coordinates to describe some characteristics predicted for the 3D mesh to a certain extent, such as vertex distribution characteristics and edge characteristics; then, predicting at least one parameter according to the image features and the projection point coordinates, so that these parameters can represent the driving parameters needed when generating the 3D mesh, so that the 3D deformable model can be subsequently driven by using the at least one parameter to obtain the 3D mesh, so that the 3D mesh can describe the state of the object in the 3D space, thus generating the 3D mesh based on the 2D images. The predicted projection point coordinates in the present application carry the edge information of the target object and the distribution information of the bone points, so that the projection point coordinates can be used in replacement of the above segmented image and the 2D bone points. Moreover, because the data amount of the projection point coordinates is relatively small, the projection point coordinates fall into the category of sparse data compared with the above segmented image, so that the computation amount of the prediction process realized based on the projection point coordinates is greatly reduced, thus making both the time overhead and computing resource overhead of the prediction process relatively small. In this way, the prediction process is suitable for deployment not only on a device with rich resources, but also on a device with limited resources, thus expanding the application range of the prediction process.

In addition, in order to better overcome the defects shown in the above ②-③, the present application also provides one possible implementation of the data processing method, in which the data processing method can include the following steps 31- 36.

Step 31: acquiring an original image, wherein the original image is used for describing the target object.

It should be noted that for the relevant contents of step 31, please refer to the above step 11.

Step 32: performing a cropping processing on the original image according to a position of the target object in the original image to obtain a cropped image, wherein the cropped image is used for describing an area indicated by the position in the original image.

It should be noted that for the relevant contents of step 32, please refer to the above step 12.

Step 33: determining the target image according to the above cropped image.

It should be noted that for the relevant contents of step 33, please refer to the above step 13.

Step 34: acquiring an affine transformation matrix, wherein the affine transformation matrix is used for indicating the corresponding relationships between pixel points in the target image and pixel points in the original image.

It should be noted that the implementation of the above step 34 is not limited in the present application, for example, it can specifically be: if the target image is a cropped image, it can be determined that the target image is obtained by performing a cropping processing for the original image, so that the affine transformation matrix is determined according to the cropping processing, so that the affine transformation matrix is used for recoding the cropping processing (for example, the affine transformation matrix = the transformation matrix for realizing the cropping processing), so that the affine transformation matrix can accurately represent what processing is performed for the pixel points in the original image to obtain the pixel points in the target image, thus enabling the affine transformation matrix to accurately represent the corresponding relationships (such as a conversion mode or a mapping mode) between the pixel points in the target image and the pixel points in the original image; if the target image is obtained by performing an adjustment processing on the cropped image according to the preset resolution, it can be determined that the target image is obtained by sequentially performing the cropping processing and the adjustment processing for the original image, and then the affine transformation matrix can be determined according to the cropping processing and the adjustment processing, so that the affine transformation matrix can be used for recording the cropping processing, the adjustment processing and the order to perform the two processings (for example, the affine transformation matrix = the transformation matrix for realizing the cropping processing × the transformation matrix for realizing the adjustment processing), so that the affine transformation matrix can accurately represent which processings are sequentially performed for the pixel points in the original image to obtain the pixel points in the target image, thus enabling the affine transformation matrix to accurately represent the corresponding relationships (such as a conversion mode or a mapping mode) between the pixel points in the target image and the pixel points in the original image.

It should also be noted that the execution time of step 34 is not limited in the present application, as long as it is ensured to be executed earlier than the execution time of step 36 below.

Step 35: predicting projection point coordinates of vertices in a 3-dimensional mesh of the target object on the target image according to image features of the target image, wherein the 3-dimensional mesh is used for describing a state of the target object in a 3-dimensional space.

It should be noted that for the relevant contents of step 35, please see the above S2.

Step 36: predicting the above at least one parameter according to the above image features and the above projection point coordinates and the above affine transformation matrix.

It should be noted that the implementation of the above step 36 is not limited in the present application, for example, it can be implemented by using any machine learning model with predictive performance or the second prediction network as shown in FIG. 2. Apparently, in one possible implementation, step 36 can specifically be: inputting the above image features, the above projection point coordinates and the above affine transformation matrix into the second prediction network to obtain at least one parameter output by the second prediction network.

Based on the related contents of the above steps 31 to 36, it can be learned that, the present application records how to obtain the target image from the original image by using the affine transformation matrix, so that the affine transformation matrix can accurately represent the conversion mode between the pixel points in the target image and the pixel points in the original image, so that the affine transformation matrix can accurately represent the position of the target object described by the target image in the original image, and consequently the global rotation parameters and global translation parameters predicted from the affine transformation matrix are attributed to the relevant parameters of the original image. In this way, these two parameters can describe the situation of global rotation and global translation presented by the original image, so as to present a relatively good rendering effect when taking these two parameters as camera external parameters for rendering.

Through research, it is found that in order to overcome the defect described in the above ④, it is possible to use the real focal length used in image shooting in the 3-dimensional reconstruction process so as to improve the prediction accuracy of other parameters. Based on this, the present application also provides one possible implementation of the data processing method, in which the data processing method can at least include the following steps 41-46.

Step 41: acquiring an original image and a focal length used when shooting the original image, wherein the original image is used for describing the target object.

In the present application, in the 3-dimensional reconstruction process, it is necessary to acquire not only the original image shot by a certain device, but also the focal length used in shooting the original image from the device, so that the focal length can accurately describe the camera internal parameters when shooting the original image, thus making other parameters (such as shape parameters, bone rotation parameters, global rotation parameters and global translation parameters) predicted based on the focal length more accurate.

Step 42: cropping the original image according to a position of the target object in the original image to obtain a cropped image, wherein the cropped image is used for describing an area indicated by the position in the original image.

It should be noted that for the relevant contents of step 42, please refer to step 12 above.

Step 43: determining the target image according to the above cropped image.

It should be noted that for the relevant contents of step 43, please refer to step 13 above.

Step 44: predicting projection point coordinates of vertices in a 3-dimensional mesh of the target object on the target image according to image features of the target image, wherein the 3-dimensional mesh is used for describing a state of the target object in a 3-dimensional space.

It should be noted that for the relevant contents of step 44, please refer to S2 above.

Step 45: predicting the above at least one parameter according to the above image features, the above projection point coordinates, and the above focal length.

It should be noted that the implementation of the above step 45 is not limited in the present application, for example, it can be implemented by using any machine learning model with prediction performance, such as the second prediction network shown in FIG. 2.

Apparently, in one possible implementation, the process of determining the at least one parameter above includes: inputting the above image features, the above projection point coordinates, the above affine transformation matrix and the above focal length into a second prediction network to obtain at least one parameter output by the second prediction network.

Based on the related contents of the above steps 41 to 45, it can be seen that, in the present application, if it is necessary to perform 3-dimensional reconstruction processing based on a certain image, a physical focal length of the camera can be acquired by the shooting device of the image, so that the physical focal length can accurately indicate what camera internal parameter is used when shooting the image with the camera, so that other parameters can be subsequently predicted based on the focal length. In this way, the solution provided by the present application has the following two advantages: the first advantage is that the characteristics of the fixed-focus camera are ensured, such as stable rendering, compatibility with some processing units (such as effects production units) configured with camera fixed-focus constraints and used for rendering the 3D mesh, and other characteristics; the second advantage is that the focal lengths of different devices can be adapted, and the real physical focal length makes the prediction results of other parameters more reliable.

Through research, it is found that in some scenes, for the execution device (such as electronic device) of the data processing method in the present application, if the image (such as the original image) processed by the device is not shot by itself, the device may not be able to acquire the focal length used in shooting the image. Therefore, in order to overcome this problem, the present application also provides a way to acquire the above focal length. In this way, when the data processing method is applied to the electronic device, the process of acquiring the focal length can include:

judging whether the focal length used in shooting the original image is stored in the storage space of the electronic device, if yes, it is possible to determine that the electronic device is the shooting device of the original image, or determine that the electronic device can acquire the shooting focal length of the original image from the shooting device of the original image in a certain way, so as to determine that the focal length stored in the storage space is the camera internal parameter actually used in shooting the original image, so that the focal length can be read from the storage space to ensure that other parameters predicted based on the focal length are more accurate; if not, it is possible to determine that the electronic device cannot acquire the shooting focal length of the original image from the shooting device of the original image, so as to acquire the preset focal length, which is regarded as the camera internal parameter used when shooting the original image. Because the preset focal length is obtained by analyzing a large number of camera internal parameters, the preset focal length can be as close as possible to the focal length used when shooting the original image, so that other parameters predicted based on the preset focal length are as accurate as possible.

In addition, in one possible implementation, in order to better improve the prediction effect, the above data processing method can be realized by means of the target model. The target model includes a feature extraction network, a first prediction network and a second prediction network; wherein the feature extraction network is used for extracting image features from a target image; the first prediction network is used for predicting projection point coordinates of vertices in a 3-dimensional mesh of the target object on the target image according to the image features; the second prediction network is used for predicting at least one parameter at least according to the image features and the projection point coordinates.

Apparently, for the data processing method realized by means of the target model, if the data processing method is used for executing a 3-dimensional reconstruction task, the data processing method can include: first, acquiring the original image shot for the target object (such as a dog); then detecting the position of the target object in the original image (the detection box as shown in FIG. 2); then, cropping an image area indicated by the position from the original image to obtain a cropped image; then scaling the cropped image to a preset resolution to obtain a target image, and acquiring an affine transformation matrix for recording the two processes of cropping and scaling; inputting the target image and the affine transformation matrix into a target model, so as to extract image features from the target image by a feature extraction network in the target model; then predicting, by a first prediction network in the target model, the projection point coordinates of the vertices in the 3-dimensional mesh of the target object on the target image according to the image features; then, predicting, by a second prediction network in the target model, the shape parameters of the target object, the bone rotation parameters of the target object, the global rotation parameters of the target object and the global translation parameters of the target object according to the image features, the projection point coordinates, the affine transformation matrix and the focal length used when shooting the original image, so that these parameters can be used for driving a 3-dimensional deformable model (such as SMAL) to obtain the 3-dimensional mesh, so as to perform some rendering processings based on the 3-dimensional mesh and the focal length, such as rendering the 3-dimensional mesh to a 3-dimensional image space based on the focal length, or rendering the 3-dimensional mesh to a 2-dimensional image space based on the focal length (such as the image space described by the original image), or rendering the 3-dimensional mesh to a space for presenting a certain effect based on the focal length.

In addition, the implementation of the target model is not limited in the present application, for example, it can be implemented by using any machine learning model including an image feature extraction network and two prediction networks.

In addition, the implementation of each network in the target model is not limited in the present application, for example, it can be implemented by using any network that can realize corresponding functions.

Furthermore, in order to better improve the effect, the present application also provides a way to train the above target model, in which when the data processing method provided by the present application is used for realizing the training process of the target model, the training process can at least include the following steps 51-58.

Step 51: acquiring an original image, wherein the original image is used for describing the target object.

In the present application, for the training process of the current round, an image can be randomly extracted from a training database (such as an image library or a video library) as the original image.

Step 52: processing the original image (such as target detection processing + cropping processing + scaling) to obtain the target image (and the affine transformation matrix).

It should be noted that for the process of acquiring the target image in step 52, please refer to the above.

Step 53: inputting the target image (and the affine transformation matrix) into the target model to obtain some information predicted by the target model, such as the projection point coordinates of vertices in the 3-dimensional mesh of the target object on the target image, and the above at least one parameter.

It should be noted that for the way to predict the projection point coordinates and the at least one parameter in step 53, please refer to the above.

Step 54: acquiring true values corresponding to the above projection point coordinates and true values corresponding to the above at least one parameter.

For any vertex in the 3-dimensional mesh of the target object, the true value corresponding to the projection point coordinate of the vertex on the target image refers to a real projection result obtained when the vertex is projected into the 2-dimensional image space described by the target image, so that the true value can represent the actual state of the vertex in the 2-dimensional space, so that the true value can represent the real characteristics owned by the vertex to a certain extent. It should be noted that the way to acquire the truth value is not limited in the present application, for example, the truth value can be acquired by manually marking or other ways.

In addition, for the above at least one parameter, if the at least one parameter includes the shape parameters of the target object, the bone rotation parameters of the target object, the global rotation parameters of the target object and the global translation parameters of the target object, the true values corresponding to the shape parameters are used for describing the shape characteristics of the target object actually presented in the original image; the true values corresponding to the bone rotation parameters are used for describing the posture characteristics of the target object actually presented in the original image; the global rotation parameters are used for describing the global rotation characteristics of the target object actually presented in the original image; the global translation parameters are used for describing the global translation characteristics of the target object actually presented in the original image. It should be noted that the way to acquire the truth values is not limited in the present application, for example, the truth values can be acquired by manually marking or other ways.

In addition, the execution time of the above step 54 is not limited in the present application.

Step 55: determining a prediction loss according to a difference between the above projection point coordinates and the true values corresponding to the projection point coordinates and a difference between the above at least one parameter and the true values corresponding to the at least one parameter, so that the loss can represent the performance of the target model in respect of prediction.

It should be noted that the implementation of the above step 55 is not limited in the present application, for example, it can be implemented by using the L1 loss function.

Step 56: determining a re-projection loss according to a difference between the projection point coordinates calculated based on the at least one parameter and the true values corresponding to the above projection point coordinates, so that the loss can more accurately represent the prediction performance of the target model for these parameters.

Through research, it is found that, for the truth values marked manually, the truth values corresponding to the above projection point coordinates are relatively accurate, but there may be certain errors in the truth values corresponding to the above at least one parameter. Therefore, in order to better evaluate the prediction performance of the target model on these parameters, acquiring at least one parameter predicted by the target model is followed by first driving the 3-dimensional deformable model by using the at least one parameter to obtain a 3-dimensional mesh; then projecting the vertices in the 3-dimensional mesh to the target image to obtain the projection point coordinates of the vertices in the 3-dimensional mesh; then determining a re-projection loss according to a difference between the projection point coordinates of the vertices in the 3-dimensional mesh and the projection positions manually marked for the vertices previously (such as the true values corresponding to the above projection point coordinates), so that the loss can better describe the prediction performance of the target model for these parameters.

It should be noted that the implementation of the above step 56 is not limited in the present application, for example, it can be implemented by using a re-projection loss function.

Step 57: determining a segmentation loss according to a difference between edge information calculated based on the at least one parameter and a segmentation result of the original image, wherein the edge information is used for describing edges predicted for the target object.

Through research, it is found that, in order to ensure that the projection point coordinates predicted by the target model can better participate in the 3-dimensional reconstruction process in replacement of the segmented image, acquiring at least one parameter predicted by the target model is followed by first driving a 3-dimensional deformable model by using the at least one parameter to obtain a 3-dimensional mesh; then rendering the 3-dimensional mesh to an image space described by the original image to obtain a rendering result, so that the rendering result can represent the state of the 3-dimensional mesh in the image space, such as edge states or other states; then processing the rendering result (such as edge extraction processing or image segmentation processing) to obtain edge information, so that the edge information can represent the edge states of the 3-dimensional mesh predicted based on the projection point coordinates, so that the edge information can describe the edges predicted for the target object based on the projection point coordinates; then determining a segmentation loss according to a difference between the edge information and the segmentation result of the original image, so that the loss can represent the performance of the target model in respect of edge prediction. The segmentation result of the original image is obtained by performing image segmentation for the original image, so that the segmentation result can at least represent edge characteristics presented in the original image. Moreover, the way to acquire the segmentation result is not limited in the present application, for example, it can be implemented by using any image segmentation method.

It should be noted that the implementation of the above step 57 is not limited in the present application, for example, it can be implemented by using a segmentation loss function based on differential rendering.

It should also be noted that the relationship between the execution time of the step 55, the execution time of step 56 and the execution time of step 57 is not limited in the present application, for example, they are the same, or they are sequentially executed in a certain order.

Step 58: updating the target model according to the prediction loss, the re-projection loss and the segmentation loss, so that the updated target model has better performance, so as to subsequently return and continue to execute the above step 51 and its subsequent steps based on the updated target model to execute the next round of training, and so on, until the preset stop condition is reached (for example, a model loss of the target model is lower than a preset loss threshold value, or a change rate of the model loss is smaller than a preset change rate threshold value, or the number of updates of the target model reaches a preset number threshold value, and other conditions) and the iterative training process for the target object is ended.

It should be noted that the model loss of the target model is used for describing the performance of the target model, and the model loss is determined according to the prediction loss, the re-projection loss and the segmentation loss. For example, the model loss is obtained by summing (or weighted summing) the prediction loss, the re-projection loss and the segmentation loss.

It should also be noted that the above step of "updating the target model" can include: updating the network parameters of each network in the target model (such as the feature extraction network, the first prediction network and the second prediction network).

Based on the related contents of the above steps 51 to 58, it can be learned that in the training process for the target model, an L1 loss function of vertices in the 3-dimensional mesh, a re-projection loss function, and a segmentation loss function based on differential rendering can be introduced to supervise the target model, so that the finally trained target model has better prediction performance, thus making the 3-dimensional reconstruction processing implemented based on the trained target model have a better effect.

In addition, the 3-dimensional reconstruction solution realized by using the data processing method provided by the present application can be applied to various scenes. For example, the 3-dimensional reconstruction solution can be used for adding a certain effect (such as wearing boots or other effects) to the original image. Moreover, the implementation process can specifically be: after processing the original image by using the 3-dimensional reconstruction solution to obtain the 3-dimensional mesh of the target object, determining a mounting anchor point corresponding to the effect from the 3-dimensional mesh according to the position information corresponding to the effect, so that the mounting anchor point includes one or more vertices in the 3-dimensional mesh; then mounting the 3-dimensional model (such as a boot model) corresponding to the effect to the anchor point to obtain the mounted 3-dimensional mesh, so that the mounted 3-dimensional mesh can be used for describing the state of the target object with the effect added in the 3-dimensional space; then rendering the 3-dimensional model in the mounted 3-dimensional mesh back to the original image to realize the purpose of rendering the effect to the 2-dimensional image, wherein the position information corresponding to the effect is used for describing the deployment position (such as an ankle) of the effect; the 3-dimensional model corresponding to the effect is used for describing the presentation of the effect.

Apparently, in one possible implementation, the above 3-dimensional reconstruction solution can be used for realizing a 3D animal (such as pet) reconstruction, that is, 3-dimensional reconstruction can be performed on the animal in the 2-dimensional image by using the 3-dimensional reconstruction solution to obtain the 3-dimensional mesh of the animal. The 3D animal reconstruction supports animal effects, for example, a cat wearing boots, and after converting from the 2D images to 3-dimensional reconstruction result (such as the 3-dimensional mesh), various effects can be mounted on it. Apparently, after the animal 3D mesh reconstruction is completed, various animal 3D effects can be supported, and the implementation process can be: it is possible to extract 25 bone key points from the animal 3D mesh as mounting anchor points, so as to realize certain effects by mounting a certain model to one or more anchor points. For example, it is possible to mount a 3D boot model at the ankle key points and render the 3D boot model into the original image, so as to realize the effect of "an animal wearing boots".

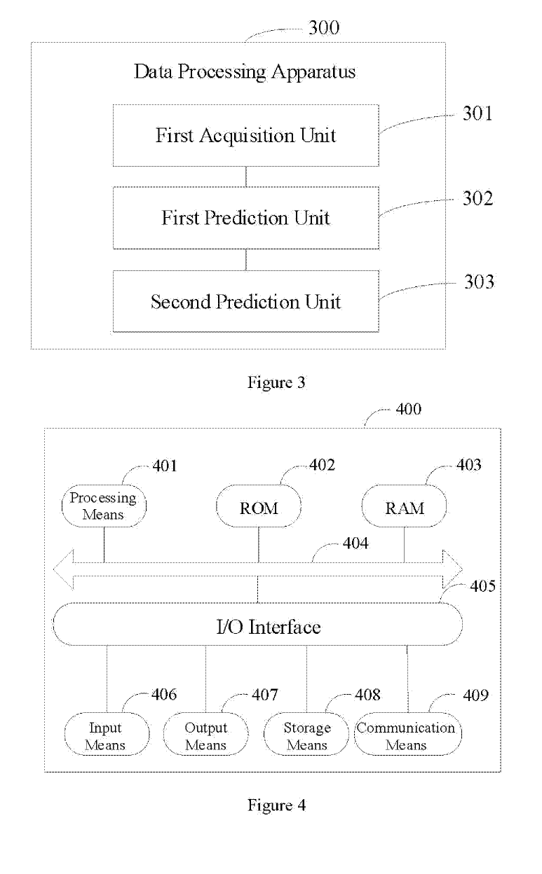

Based on the data processing method provided by the embodiment of the present application, an embodiment of the present application also provides a data processing apparatus, which will be explained and illustrated in combination with FIG. 3. FIG. 3 is a schematic structural diagram of a data processing apparatus provided by an embodiment of the present application. It should be noted that for the technical details of the data processing apparatus provided by the embodiment of the present application, please refer to the relevant contents of the data processing method above.

As shown in FIG. 3, a data processing apparatus 300 provided by an embodiment of the present application includes:

a first acquisition unit 301 for acquiring a target image, wherein the target image is used for describing a target object;

a first prediction unit 302 for predicting projection point coordinates of vertices in a 3-dimensional mesh of the target object on the target image according to image features of the target image, wherein the 3-dimensional mesh is used for describing a state of the target object in a 3-dimensional space;

a second prediction unit 303 for predicting at least one parameter according to the image features and the projection point coordinates, wherein the at least one parameter is used for driving a 3-dimensional deformable model to obtain the 3-dimensional mesh.

In one possible implementation, the at least one parameter includes shape parameters of the target object, bone rotation parameters of the target object, global rotation parameters of the target object and global translation parameters of the target object.

In one possible implementation, the first prediction unit 302 is specifically used for: predicting projection point coordinates of all vertices in the 3-dimensional mesh on the target image according to the image features; or predicting projection point coordinates of a portion of vertices in the 3-dimensional mesh on the target image according to the image features, wherein the importance degree of the portion of vertices is higher than that of the vertices other than the portion of all the vertices.

In one possible implementation, the data processing apparatus 300 is deployed in an electronic device, and the data processing apparatus 300 further includes:

a constraint determination unit for determining a 3-dimensional reconstruction constraint according to 3-dimensional reconstruction requirements of the electronic device and/or a resource usage state of the electronic device, wherein the 3-dimensional reconstruction constraint is used for indicating a usage upper limit of a 3-dimensional reconstruction process realized based on the target image with at least one resource, and the at least one resource comprises a portion or all of various computing resources and time;

the first prediction unit 302 is specifically used for: if the usage upper limit indicated by the 3-dimensional reconstruction constraint exceeds a preset threshold value, predicting projection point coordinates of all vertices in the 3-dimensional mesh on the target image according to the image features; if the usage upper limit indicated by the 3-dimensional reconstruction constraint does not exceed the preset threshold value, predicting projection point coordinates of a portion of vertices in the 3-dimensional mesh on the target image according to the image features.

In one possible implementation, the first acquisition unit 301 is specifically used for: acquiring an original image, wherein the original image is used for describing the target object; performing a cropping processing on the original image according to a position of the target object in the original image to obtain a cropped image, wherein the cropped image is used for describing an area indicated by the position in the original image; determining the target image according to the cropped image.

In one possible implementation, the first acquisition unit 301 is specifically used for: performing an adjustment processing on the cropped image according to a preset resolution to obtain the target image, wherein a resolution of the target image is the preset resolution, and the preset resolution is smaller than that of the cropped image.

In one possible implementation, the data processing apparatus 300 further includes:

a second acquisition unit for acquiring an affine transformation matrix, wherein the affine transformation matrix is used for indicating the corresponding relationships between pixel points in the target image and pixel points in the original image;

the second prediction unit 303 is specifically used for predicting the at least one parameter according to the image features, the projection point coordinates and the affine transformation matrix.

In one possible implementation, the target image is the cropped image, and the affine transformation matrix is determined according to the cropping processing; or the target image is obtained by performing an adjustment processing on the cropped image according to a preset resolution, and the affine transformation matrix is determined according to the cropping processing and the adjustment processing.

In one possible implementation, the data processing apparatus 300 further includes:

a third acquisition unit for acquiring a focal length used when shooting the original image;

the second prediction unit 303 is specifically used for predicting the at least one parameter according to the image features, the projection point coordinates and the focal length.

In one possible implementation, the data processing apparatus 300 is deployed in an electronic device, and the third acquisition unit is specifically used for: if the focal length used when shooting the original image is stored in a storage space of the electronic device, reading the focal length from the storage space; if the focal length used when shooting the original image is not stored in a storage space of the electronic device, acquiring a preset focal length.

In one possible implementation, the at least one parameter is determined by using a target model, and the target model includes a feature extraction network, a first prediction network and a second prediction network; the feature extraction network is used for extracting the image features from the target image; the first prediction network is used for predicting projection point coordinates of vertices in the 3-dimensional mesh on the target image according to the image features; the second prediction network is used for predicting at least one parameter according to the image features and the projection point coordinates.

In one possible implementation, the target image is obtained by processing the original image;

the data processing apparatus 300 further includes:

a fourth acquisition unit for acquiring true values corresponding to the projection point coordinates and true values corresponding to the at least one parameter;

a first calculation unit for determining a prediction loss according to a difference between the projection point coordinates and the true values corresponding to the projection point coordinates and a difference between the at least one parameter and the true values corresponding to the at least one parameter;

a second calculation unit for determining a re-projection loss according to a difference between the projection point coordinates calculated based on the at least one parameter and the true values corresponding to the projection point coordinates;

a third calculation unit for determining a segmentation loss according to a difference between edge information calculated based on the at least one parameter and a segmentation result of the original image, wherein the edge information is used for describing edges predicted for the target object;

a model update unit for updating the target model according to the prediction loss, the re-projection loss and the segmentation loss.

Based on the related contents of the above data processing apparatus 300, it can be learned that, the working principle of the apparatus 300 includes: after acquiring the target image for describing the target object (such as an animal), first predicting projection point coordinates of vertices in a 3D mesh of the target object on the target image according to image features of the target image, so that the projection point coordinates can indicate the corresponding relationships between pixel points in the target image and the vertices in the 3D mesh, thus enabling the projection point coordinates to describe some characteristics predicted for the 3D mesh to a certain extent, such as vertex distribution characteristics and edge characteristics; then, predicting at least one parameter according to the image features and the projection point coordinates, so that these parameters can represent the driving parameters needed when generating the 3D mesh, so as to drive the 3D deformable model by using the at least one parameter to obtain the 3D mesh, so that the 3D mesh can describe the state of the object in the 3D space, thus generating the 3D mesh based on the 2D images.

In addition, an embodiment of the present application also provides an electronic device, which comprises a processor and a memory, wherein the memory is used for storing instructions or computer programs; the processor is used for executing the instructions or computer programs in the memory, so that the electronic device can execute any implementation of the data processing method provided by the embodiment of the present application.

Referring to FIG. 4, there is shown a structural schematic diagram of an electronic device 400 suitable for implementing an embodiment of the present disclosure. The terminal device in the embodiment of the present disclosure can include, but is not limited to, a mobile terminal such as a mobile phone, a notebook computer, a digital broadcast receiver, a Personal Digital Assistant (PDA), a Tablet Computer (PAD), a Portable Multimedia Player (PMP), a vehicle-mounted terminal (such as a vehicle-mounted navigation terminal), and a fixed terminal such as digital TV and a desktop computer. The electronic device shown in FIG. 4 is only an example, and should not bring any limitation to the functions and application scope of the embodiment of the present disclosure.

As shown in FIG. 4, an electronic device 400 can include a processing means (such as a central processing unit, a graphics processor, etc.) 401, which can perform various appropriate actions and processings according to a program stored in a read-only memory (ROM)402 or a program loaded from a storage means 408 into a random access memory (RAM)403. In the RAM403, various programs and data required for the operation of the electronic device 400 are also stored. The processing means 401, the ROM 402 and the RAM 403 are connected to each other through a bus 404. An input/output (I/O) interface 405 is also connected to the bus 404.

Generally, the following means can be connected to the I/O interface 405: an input means 406 including, for example, a touch screen, a touch pad, a keyboard, a mouse, a camera, a microphone, an accelerometer, a gyroscope, etc.; an output means 407 including, for example, a liquid crystal display (LCD), a speaker, a vibrator, etc; a storage means 408 including, for example, a magnetic tape, a hard disk, etc; and a communication means 409. The communication means 409 can allow the electronic device 400 to perform wireless or wired communication with other devices to exchange data. Although FIG. 4 shows an electronic device 400 with various means, it should be understood that it is not required to implement or provide all the means shown. More or fewer means may alternatively be implemented or provided.

In particular, according to an embodiment of the present disclosure, the process described above with reference to the flow diagram can be implemented as a computer software program. For example, an embodiment of the present disclosure includes a computer program product including computer programs carried on a non-transitory computer-readable medium, the computer programs comprising program codes for performing the method shown in the flow diagram. In such an embodiment, the computer programs can be downloaded and installed from the network through the communication means 409, or installed from the storage means 408, or installed from the ROM 402. When the computer programs are executed by the processing means 401, the above functions defined in the method of the embodiment of the present disclosure are performed.

The electronic device provided by the embodiment of the present disclosure belongs to the same inventive concept as the method provided by the above embodiment, and the technical details not described in detail in the present embodiment can refer to the above embodiment, and the present embodiment has the same beneficial effects as the above embodiment.

An embodiment of the present application also provides a computer-readable medium, wherein instructions or computer programs are stored in the computer-readable medium, and when run on a device, cause the device to execute any implementation of the data processing method provided by the embodiment of the present application.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. More specific examples of the computer-readable storage medium can include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium containing or storing programs, which can be used by or in combination with an instruction execution system, apparatus or device. In the present disclosure, the computer-readable signal medium can include a data signal propagated in baseband or as a portion of a carrier wave, in which computer-readable program codes are carried. This propagated data signal can take many forms, including but not limited to electromagnetic signals, optical signals or any suitable combination of the above. The computer-readable signal medium can also be any computer-readable medium other than the computer-readable storage medium, which can send, propagate or transmit programs for use by or in connection with an instruction execution system, apparatus or device. The program codes contained in the computer-readable medium can be transmitted by any suitable medium, including but not limited to: wires, optical cables, RF (radio frequency) and the like, or any suitable combination of the above.

In some implementations, the client and the server can communicate by using any currently known or future developed network protocol such as Hyper Text Transfer Protocol (HTTP), and can be interconnected with digital data communication in any form or medium (for example, a communication network). Examples of the communication network include a local area network ("LAN"), a wide area network ("WAN"), the Internet (for example, the Internet) and end-to-end networks (for example, ad hoc end-to-end networks), as well as any currently known or future developed networks.

The above computer-readable medium can be included in the above electronic device, or it can exist alone without being assembled into the electronic device.

The above computer-readable medium carries one or more programs which, when executed by the electronic device, cause the electronic device to perform the above method.

Computer program codes for performing the operations of the present disclosure can be written in one or more programming languages or their combinations, including but not limited to object-oriented programming languages, such as Java, Smalltalk, C++, and conventional procedural programming languages, such as "C" language or similar programming languages. The program codes can be completely executed on a user computer, partially executed on the user computer, executed as an independent software package, partially executed on the user computer and partially executed on a remote computer, or completely executed on the remote computer or a server. In the case involving the remote computer, the remote computer can be connected to a user computer through any kind of network, including a local area network (LAN) or a wide area network (WAN), or can be connected to an external computer (for example, through the Internet using an Internet service provider).

The flow diagrams and block diagrams in the drawings illustrate the architecture, functions and operations of possible implementations of the system, the method and the computer program product according to various embodiments of the present disclosure. In this regard, each block in the flow diagrams or block diagrams can represent a module, a program segment, or a portion of codes that contains one or more executable instructions for implementing specified logical functions. It should also be noted that in some alternative implementations, the functions noted in the blocks can occur in a different order than those noted in the drawings. For example, two blocks shown in succession can actually be executed substantially in parallel, and they can sometimes be executed in the reverse order, depending on the functions involved. It should also be noted that each or a combination of blocks in the block diagrams and/or flow diagrams can be implemented by a dedicated hardware-based system for implementing specified functions or operations, or by a combination of dedicated hardware and computer instructions.

The units involved in the embodiments described in the present disclosure can be implemented by software or hardware. The name of the unit/module does not constitute the limitation of the unit itself in some cases.

The functions described above herein can be at least partially performed by one or more hardware logic components. For example, without limitation, exemplary types of hardware logic components that can be used include: a Field Programmable Gate Array (FPGA), an Application Specific Integrated Circuit (ASIC), an Application Specific Standard Product (ASSP), a System on Chip (SOC), a Complex Programmable Logic Device (CPLD) and so on.

In the context of the present disclosure, a machine-readable medium can be a tangible medium that can contain or store a program for use by or in connection with an instruction execution system, apparatus or device. The machine-readable medium can be a machine-readable signal medium or a machine-readable storage medium. The machine-readable medium can include, but is not limited to, an electronic, magnetic, optical, electromagnetic, infrared, or semiconductor system, apparatus or device, or any suitable combination of the above. More specific examples of the machine-readable storage medium can include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that each embodiment in this specification is described in a progressive way, and each embodiment focuses on the differences from other embodiments, so it is only necessary to refer to the same and similar parts between the embodiments. As for the system or device disclosed in the embodiment, because it corresponds to the method disclosed in the embodiment, the description is relatively simple, and the relevant points can refer to the description of the method part.

It should be understood that in the present application, "at least one (item)" means one or more, and "multiple" means two or more. "and/or" is used to describe the association relationships of associated objects, indicating that there can be three kinds of relationships. For example, "A and/or B" can indicate that there are three instances of only A, only B and both A and B, where A or B can be singular or plural. The character "/"generally indicates that the associated objects are in an “OR” relationship. "At least one of the following items" or its similar expression means any combination of these items, including any combination of single items or plural items. For example, at least one of a, b or c can be expressed as: a, b, c, “a and b”, “a and c”, “b and c”, or “a and b and c”, where a, b, and c can be single or multiple.

It should also be noted that, relational terms such as first and second herein are only used to distinguish one entity or operation from another entity or operation, and do not necessarily require or imply that there is any such actual relationship or order between these entities or operations. Moreover, the terms "including", "comprising" or any other variation thereof are intended to cover non-exclusive inclusion, so that a process, method, article or device including a series of elements includes not only those elements, but also other elements not explicitly listed or elements inherent to such process, method, article or device. Without further restrictions, an element defined by the phrase "including one ..." does not exclude the existence of other identical elements in the process, method, article or device including the element.

The steps of a method or algorithm described in connection with the embodiments disclosed herein can be directly implemented in hardware, a software module executed by a processor, or a combination of the two. The software module can be disposed in a random access memory (RAM), an internal memory, a read-only memory (ROM), an electrically programmable (ROM), an electrically erasable programmable (ROM), a register, a hard disk, a removable disk, a CD-ROM, or any other form of storage medium known in the technical field.

The above description of the disclosed embodiments enables those skilled in the art to implement or use the present application. Many modifications to these embodiments will be obvious to those skilled in the art, and the general principles defined herein can be implemented in other embodiments without departing from the spirit or scope of the present application. Therefore, the present application will not be limited to these embodiments shown herein, but is to be accorded the widest scope consistent with the principles and novel features disclosed herein.

What is claimed is:

1. A data processing method, comprising:
acquiring a target image, wherein the target image is configured for describing a target object;
predicting projection point coordinates of vertices in a 3-dimensional mesh of the target object on the target image according to image features of the target image, wherein the 3-dimensional mesh is configured for describing a state of the target object in a 3-dimensional space;
predicting at least one parameter according to the image features and the projection point coordinates, wherein the at least one parameter is configured for driving a 3-dimensional deformable model to obtain the 3-dimensional mesh.

2. The method according to claim 1, wherein the at least one parameter comprises shape parameters of the target object, bone rotation parameters of the target object, global rotation parameters of the target object and global translation parameters of the target object.

3. The method according to claim 1, wherein the predicting projection point coordinates of vertices in the 3-dimensional mesh of the target object on the target image according to image features of the target image comprises:
predicting the projection point coordinates of all vertices in the 3-dimensional mesh on the target image according to the image features;
or,
predicting the projection point coordinates of a portion of vertices in the 3-dimensional mesh on the target image according to the image features, wherein the importance degree of the portion of vertices is higher than that of the vertices other than the portion in all the vertices.

4. The method according to claim 3, wherein the method is applied to an electronic device, and the method further comprises:
determining a 3-dimensional reconstruction constraint according to at least one of 3-dimensional reconstruction requirements of the electronic device or a resource usage state of the electronic device, wherein the 3-dimensional reconstruction constraint is configured for indicating a usage upper limit of a 3-dimensional reconstruction process realized based on the target image with at least one resource, and the at least one resource comprises a portion or all of various computing resources and time;
the predicting projection point coordinates of vertices comprises:
if the usage upper limit indicated by the 3-dimensional reconstruction constraint exceeds a preset threshold value, predicting the projection point coordinates of all the vertices in the 3-dimensional mesh on the target image according to the image features;
if the usage upper limit indicated by the 3-dimensional reconstruction constraint does not exceed the preset threshold value, predicting the projection point coordinates of a portion of the vertices in the 3-dimensional mesh on the target image according to the image features.

5. The method according to claim 1, wherein the acquiring process of the target image comprises:
acquiring an original image, wherein the original image is configured for describing the target object;
performing a cropping processing on the original image according to a position of the target object in the original image to obtain a cropped image, wherein the cropped image is configured for describing an area indicated by the position in the original image;
determining the target image according to the cropped image.

6. The method according to claim 5, wherein the determining the target image according to the cropped image comprises:
performing an adjustment processing on the cropped image according to a preset resolution to obtain the target image, wherein a resolution of the target image is the preset resolution, and the preset resolution is smaller than a resolution of the cropped image.

7. The method according to claim 5, wherein the method further comprises:
acquiring an affine transformation matrix, wherein the affine transformation matrix is configured for indicating corresponding relationships between pixel points in the target image and pixel points in the original image;
the predicting the at least one parameter according to the image features and the projection point coordinates comprises:
predicting the at least one parameter according to the image features, the projection point coordinates, and the affine transformation matrix.

8. The method according to claim 7, wherein the target image is the cropped image, and the affine transformation matrix is determined according to the cropping processing;
or,
the target image is obtained by performing an adjustment processing on the cropped image according to the preset resolution, and the affine transformation matrix is determined according to the cropping processing and the adjustment processing.

9. The method according to claim 5, wherein the method further comprises:
acquiring a focal length used when shooting the original image;
the predicting the at least one parameter according to the image features and the projection point coordinates comprises:
predicting the at least one parameter according to the image features, the projection point coordinates and the focal length.

10. The method according to claim 9, wherein the method is applied to an electronic device;
the acquiring the focal length comprises:
if the focal length used when shooting the original image is stored in a storage space of the electronic device, reading the focal length from the storage space;
if the focal length used when shooting the original image is not stored in a storage space of the electronic device, acquiring a preset focal length.

11. The method according to claim 1, wherein the at least one parameter is determined by using a target model, and the target model comprises a feature extraction network, a first prediction network and a second prediction network;
the feature extraction network is configured for extracting the image features from the target image;
the first prediction network is configured for predicting the projection point coordinates of vertices in the 3-dimensional mesh on the target image according to the image features;
the second prediction network is configured for predicting the at least one parameter according to the image features and the projection point coordinates.

12. The method according to claim 11, wherein the target image is obtained by processing the original image;
the method further comprises:
acquiring true values corresponding to the projection point coordinates and true values corresponding to the at least one parameter;
determining a prediction loss according to a difference between the projection point coordinates and the true values corresponding to the projection point coordinates and a difference between the at least one parameter and the true values corresponding to the at least one parameter;
determining a re-projection loss according to a difference between the projection point coordinates calculated based on the at least one parameter and the true values corresponding to the projection point coordinates;
determining a segmentation loss according to a difference between edge information calculated based on the at least one parameter and a segmentation result of the original image, wherein the edge information is configured for describing the edges predicted for the target object;
updating the target model according to the prediction loss, the re-projection loss and the segmentation loss.

13. An electronic device, comprising: a processor and a memory;
the memory is configured for storing instructions or computer programs;
the processor is configured for executing the instructions or computer programs in the memory, so that the electronic device performs a data processing method, comprising:
acquiring a target image, wherein the target image is configured for describing a target object;
predicting projection point coordinates of vertices in a 3-dimensional mesh of the target object on the target image according to image features of the target image, wherein the 3-dimensional mesh is configured for describing a state of the target object in a 3-dimensional space;
predicting at least one parameter according to the image features and the projection point coordinates, wherein the at least one parameter is configured for driving a 3-dimensional deformable model to obtain the 3-dimensional mesh.

14. The electronic device according to claim 13, wherein the at least one parameter comprises shape parameters of the target object, bone rotation parameters of the target object, global rotation parameters of the target object and global translation parameters of the target object.

15. The electronic device according to claim 13, wherein the predicting projection point coordinates of vertices in the 3-dimensional mesh of the target object on the target image according to image features of the target image comprises:
predicting the projection point coordinates of all vertices in the 3-dimensional mesh on the target image according to the image features;
or,
predicting the projection point coordinates of a portion of vertices in the 3-dimensional mesh on the target image according to the image features, wherein the importance degree of the portion of vertices is higher than that of the vertices other than the portion in all the vertices.

16. The electronic device according to claim 15, wherein the method is applied to an electronic device, and the method further comprises:
determining a 3-dimensional reconstruction constraint according to at least one of 3-dimensional reconstruction requirements of the electronic device or a resource usage state of the electronic device, wherein the 3-dimensional reconstruction constraint is configured for indicating a usage upper limit of a 3-dimensional reconstruction process realized based on the target image with at least one resource, and the at least one resource comprises a portion or all of various computing resources and time;
the predicting projection point coordinates of vertices comprises:
if the usage upper limit indicated by the 3-dimensional reconstruction constraint exceeds a preset threshold value, predicting the projection point coordinates of all the vertices in the 3-dimensional mesh on the target image according to the image features;
if the usage upper limit indicated by the 3-dimensional reconstruction constraint does not exceed the preset threshold value, predicting the projection point coordinates of a portion of the vertices in the 3-dimensional mesh on the target image according to the image features.

17. A non-transitory computer-readable medium, characterized in that instructions or computer programs are stored in the computer-readable medium, and when run on a device, cause the device to perform a data processing method, comprising:
acquiring a target image, wherein the target image is configured for describing a target object;
predicting projection point coordinates of vertices in a 3-dimensional mesh of the target object on the target image according to image features of the target image, wherein the 3-dimensional mesh is configured for describing a state of the target object in a 3-dimensional space;
predicting at least one parameter according to the image features and the projection point coordinates, wherein the at least one parameter is configured for driving a 3-dimensional deformable model to obtain the 3-dimensional mesh.

18. The non-transitory computer-readable medium according to claim 17, wherein the at least one parameter comprises shape parameters of the target object, bone rotation parameters of the target object, global rotation parameters of the target object and global translation parameters of the target object.

19. The non-transitory computer-readable medium according to claim 17, wherein the predicting projection point coordinates of vertices in the 3-dimensional mesh of the target object on the target image according to image features of the target image comprises:
predicting the projection point coordinates of all vertices in the 3-dimensional mesh on the target image according to the image features;
or,
predicting the projection point coordinates of a portion of vertices in the 3-dimensional mesh on the target image according to the image features, wherein the importance degree of the portion of vertices is higher than that of the vertices other than the portion in all the vertices.

20. The non-transitory computer-readable medium according to claim 19, wherein the method is applied to an electronic device, and the method further comprises:
determining a 3-dimensional reconstruction constraint according to at least one of 3-dimensional reconstruction requirements of the electronic device or a resource usage state of the electronic device, wherein the 3-dimensional reconstruction constraint is configured for indicating a usage upper limit of a 3-dimensional reconstruction process realized based on the target image with at least one resource, and the at least one resource comprises a portion or all of various computing resources and time;
the predicting projection point coordinates of vertices comprises:
if the usage upper limit indicated by the 3-dimensional reconstruction constraint exceeds a preset threshold value, predicting the projection point coordinates of all the vertices in the 3-dimensional mesh on the target image according to the image features;
if the usage upper limit indicated by the 3-dimensional reconstruction constraint does not exceed the preset threshold value, predicting the projection point coordinates of a portion of the vertices in the 3-dimensional mesh on the target image according to the image features.
